(19) United States
(12) Patent Application Publication
(10) Pub. No.: US 2018/0355701 A1
(43) Pub. Date: Dec. 13, 2018

(54) HYDRAULIC FRACTURING SIMULATION

(71) Applicant: Rockfield Software Limited, Swansea (GB)

(72) Inventors: Martin Dutko, Swansea (GB); James Armstrong, Swansea (GB); Attila Garai, Swansea (GB)

(21) Appl. No.: 16/001,215

(22) Filed: Jun. 6, 2018

(30) Foreign Application Priority Data
Jun. 7, 2017 (GB) 1709057.2

(51) Int. Cl. E21B 41/00; G06F 17/50; E21B 43/26; E21B 49/08

(52) U.S. Cl. CPC E21B 41/0092; G06F 17/5018; G06F 2217/16; E21B 49/08; E21B 43/26

(57) ABSTRACT

The present invention provides an apparatus and computer implemented methods of modelling a hydraulically driven fracture. A computer implemented method of modelling a hydraulically driven fracture comprises predicting the direction and the geometry of a fracture using a finite element method, and inserting a new fracture into the model using a geometric insertion technique.

### CROSS REFERENCE TO RELATED APPLICATIONS

This application claims priority to United Kingdom Patent Application No. 1709057.2, filed Jun. 7, 2017, the contents of which are incorporated herein by reference in their entirety for all purposes.

### INTRODUCTION

This invention relates to computer implemented methods of modelling a hydraulically driven fracture. In particular, the present invention relates to the simulation of hydraulic fracture in hydrocarbon reservoirs along with the flow of the fracturing fluid within the fracture as it dynamically propagates.

Hydraulic fracturing is an engineering process used by the oil industry to extract hydrocarbon deposits from reservoirs that are unsuitable for conventional drilling methods and would otherwise be deemed uneconomical. The pumping of hydraulic fluids causes fracture propagation and these fractures can extend significantly into the reservoir. Hydraulic fracturing is a desirable technique for many reservoirs across the world, so many engineers are attempting to optimise this technique.

The exact fracture propagation through the reservoir is naturally hidden from the engineer. Therefore, data from secondary sources (e.g. micro-seismic measurements, interpreting pressure evolution of hydraulic fluid at the perforation cluster) used to be the only way of estimating the fracture direction and length. The development of computer implemented simulations, such as sophisticated 3D modelling software, greatly enhances the understanding of the key processes involved in a hydraulic fracturing event.

Traditionally, analytical methods provide a simple means of estimating the relationship between important variables such as, say, pumped fluid volume and the resulting fracture width and length. However, the assumptions within analytical models are well known to be inadequate. For example, the general shape of the fracture acts as a constraint on the fracture growth in the case of the Geertsma-de Klerk (GDK) and Perkins-Kern-Nordgren Model (PKN) analytical models, therefore prohibiting the model to capture truly arbitrary fracture shapes. Additionally, important non-linear processes, such as inelastic fracture mechanics, are often omitted from analytical methods. There is therefore a need for a numerical method which can model the propagation of hydraulically driven fractures more accurately that an analytical method.

Efforts have been made in both industry and academia to develop a numerical tool capable of simulating 3D hydraulic fracturing. However, the majority of the simulation tools assume linear elastic fracture mechanics (LEFM) which is not capable of determining fracture growth in a broad range of rock types, whether they be soft rocks (e.g. clays or weakly consolidated sandstones) or hard rocks (e.g. low porosity shales or granite). Non-linear elastic fracture mechanics permits ductility to form ahead of the fracture tip and this yields very different fracture geometry predictions when compared against LEFM software tools.

It is known to use finite element methods in hydraulic fracturing simulations. An example of such a method is disclosed in U.S. Pat. No. 9,405,867, in which the Extend Finite Element Method (XFEM) is applied to hydraulic fracture modelling. The method involves the splitting of mesh elements and nodes and does not require any remeshing. However, the numerical simulation is complicated, especially as level set methods are necessary to follow the fracture tip growth.

There is therefore a need for a method that can simulate propagation for 2D & 3D arbitrary hydraulically driven fracture paths, which are a complex function of, amongst other parameters; pump rates, in-situ stress, material state and whether the reservoir is predominantly homogenous or strongly heterogeneous as would be the case in a laminated reservoir. The method should be computationally efficient.

### SUMMARY OF THE INVENTION

In a first aspect of the present invention, there is provided a computer implemented method of modelling a hydraulically driven fracture, comprising:
predicting the direction and geometry of a fracture using a finite element method; and
inserting a new fracture into the model using a geometric insertion technique.

Thus, the present invention provides a computer implemented method defining a discrete fracture geometry and evolving mesh (a feature of the finite element method) that predicts hydraulic fracture growth in hydrocarbon reservoirs. Fracture insertion is carried out using a geometric approach rather than the splitting of mesh elements and nodes. This results in a smooth fracture geometry. In addition, the mesh quality is maintained throughout a hydraulic fracture analysis with no significant drop in the time step value. This ensures efficient, feasible simulation times for the explicit solution of the displacement of the mesh nodes and stresses at the finite element level.

A technical effect of the present invention is that it provides a more realistic model of a hydraulically driven fracture, which means that hydrocarbon deposits from reservoirs that are unsuitable for conventional drilling methods can be further extracted using a safer, more reliable process designed using the claimed method.

The present invention may further comprise the step of modifying the fracture geometry to ensure that the direction and length of the fracture is physically realistic and/or to mitigate geometric details which may cause meshing difficulties and/or small time steps. The step of modifying the fracture geometry may include extending or trimming the predicted fracture geometry with respect to a pre-existing fracture geometric entity, such as another fracture or inter-bed.

The method may include simulation of fracture propagation along a 2D, or a 3D path. In other words, the present invention may be capable of 2D or 3D modelling. The method may include predicting the direction and the geometry of a fracture in either two dimensions or three dimensions.

The method may include conducting remeshing of the model after inserting the new fracture. The remeshing may be global or local.

In some embodiments, the method includes conducting local remeshing of the model proximate the tip of the fracture.

Thus, the present invention may provide a simulation method with a local adaptive remeshing technique, whereby an initial coarse mesh is refined only at the fracture tip. Typically, existing finite element modelling methods require a global remesh of the whole simulated domain each time remeshing is required. Not only is this method computational prohibitive at large 2D & 3D scale industrial modelling, it also introduces undesirable consequences such as dispersion as material state parameters are mapped between old and new meshes. Hence, the local remeshing procedures proposed herein overcome this issue by reducing computational cost and time and avoiding numerical problems such as dispersion.

The method may include modelling the pressure evolution and flow of the hydraulic fluid in the fracture ensuring that the fracture growth and flow of the hydraulic fluid are continuous processes.

The method may include modelling the lag of the hydraulic fluid at the fracture tip, whereby the node of the finite element mesh at the new fracture tip can be assigned a prescribed initial pressure. The prescribed initial pressure may be a user-specific pressure. Optionally, the method may include modifying the initial pressure value using the reservoir pore pressure.

The pressure along the length of the newly inserted fracture extension can be assigned using either constant value, or linear interpolation from the prescribed value at the new fracture tip to the value at the tip of previous fracture.

Optionally, the finite element method used is a finite element-discrete element method [reference to A. Munjiza: The Combined Finite-Discrete Element Method. Wiley 2004. DOI: 10.1002/0470020180, the contents of which are incorporated herein by reference as though fully set forth herein]. Optionally, the method may use a combined finite-discrete element method.

The method may involve predicting the stress evolution of the fracture (i.e. within the rock) using the finite element method.

The method may include modelling evolution of the pressure flow of the hydraulic fluid using the finite element method.

The direction and/or length of the fracture may be predicted using a non-local damage prediction approach. The non-local damage prediction approach may utilise the Mohr-Coulomb with a Rankine cap constitutive model with the later able to capture mode-1 fracture (tensile), and/or other constitutive models for mode-II (in-plane shear), and/or mode-III (out-of-plane shear) fracture criteria. This approach is described in detail in the specific description.

In some embodiments, the non-local fraction prediction approach may include taking account of one or more of: stress state, material properties, heterogeneity, leak-off of fracturing fluid, and/or pore pressure fluid at the fracture tip. Conventionally, the path of the fracture in the model is dictated by topology of the mesh, rather than these properties. Thus, the method of the present invention provides mesh independent and more accurate simulation of the fracture propagation.

Optionally, the finite element method (such as the combined finite-discrete element method) may take account of pre-existing interfaces or reservoir layers encountered by the fracture represented as discrete geometry lines or planes. Thus, the method of the present invention may therefore provide a more realistic framework to simulate the interaction between hydraulic fractures and pre-existing interfaces.

The method may comprise rebuilding the model geometry and mesh following the insertion of a new fracture.

The step of rebuilding the model geometry and mesh may include mapping the stresses and material state parameters between old and new regions of the mesh (i.e. between regions which have been remeshed).

In a second aspect of the present invention, there is provided a computer implemented method of modelling a hydraulically driven fracture, comprising:
predicting the direction and geometry of a fracture using a finite element method;
inserting a new fracture into the model; and
conducting local remeshing of the model proximate the tip of the fracture.

As explained above, local remeshing is computational more efficient than global remeshing, which is advantageous. By reducing computation time the present invention thus provides a more efficient method of accurately simulating the propagation of hydraulically driven fractures, which can be used to optimise hydraulic extraction processes.

The method of local remeshing proximate to the fracture tip may comprise one or more of following steps:
marking the elements of the finite element mesh identified during a non-local damage calculation as seed elements;
assigning a new mesh density (new element sizes) to the seed elements;
expanding the domain to be remeshed around the seed elements in order to achieve a mesh density gradient above a given threshold, wherein the seed elements and the elements in expanded domain are referred to as dead elements;
performing a remeshing of the finite element mesh in the domain defined by dead elements only.

Optionally, the method may be a combined finite-discrete element method.

It should be appreciated that the second aspect of the invention may comprise any feature defined in the first aspect of the invention, and vice versa.

In a third aspect of the invention, there is provided a method of extracting hydrocarbon deposits via hydraulic fracturing, the method comprising:
modelling a hydraulically driven fracture using the computer implemented method of the first or second aspects of the invention; and
determining one or more parameters of the extraction process by optimising the model.

Optionally, the parameter(s) optimised by the computer implemented method include one or more of: the extraction location, the pressure of the hydraulic fluid, fracture dimension (length, height, and width), evolution of the effective stress and pressure in the reservoir, and/or the duration of the extraction process.

Proppant placement is a generic term used to describe into which parts of the fracture the proppant has been delivered by the fracturing fluid, what is its concentration in those areas, and how much it is keeping the fracture open (“propped”) during the production.

The method may further include the step of pumping hydraulic fluid into a wellbore as per the computer implemented model.

Thus, the method of the present invention may include the step of initiating a hydraulic fracturing process to extract hydrocarbon deposits, wherein one or more of the parameters of the hydraulic fracturing process have been determined by optimising the computer implemented method (i.e. the modelling). Thus, the present invention provides a method of optimising the extraction of hydrocarbon deposits via hydraulic fracturing. It will therefore be appreciated that the present invention is not limited to computer implemented steps.

Optionally, the method may include the step of calibrating microseismic measurements during hydraulic fracturing process, and/or during hydrocarbon production.

It should be appreciated that the third aspect of the invention includes any embodiment or example of the first and second aspects of the invention.

In a fourth aspect of the present invention, there is provided an apparatus for modelling a hydraulically driven fracture, the apparatus comprising a processing unit comprising:
a fracture predictor module for predicting the direction and geometry of a fracture using a finite element method; and
a fracture geometry inserter module configured to insert a new fracture into the model using a geometric insertion technique.

Optionally, the apparatus may further comprise a fracture tip mesher module configured to conduct remeshing of the model, wherein the remeshing may be global or local. In some embodiments the fracture tip mesher module may be configured to conduct local remeshing proximate the fracture tip.

Optionally, the apparatus may further comprise a fracture rule modifier module configured to ensure that the direction and length of the fracture is physically realistic and/or to mitigate geometric details which may cause meshing difficulties.

The apparatus may comprise a model rebuild module configured to:
i) rebuild the model geometry and mesh, inserting the new fracture tip geometry; and
ii) map the stresses and material state parameters between old and new regions of the mesh.

Optionally, the apparatus may further comprise a display unit to display the output of the processing unit. Thus, the display unit may display the evolution of a hydraulically driven fracture.

The apparatus may be configured to perform the method of any embodiment of the first or second aspects of the invention.

### DETAILED DESCRIPTION

Illustrative embodiments of the invention will now be described with reference to the accompanying drawings, in which:

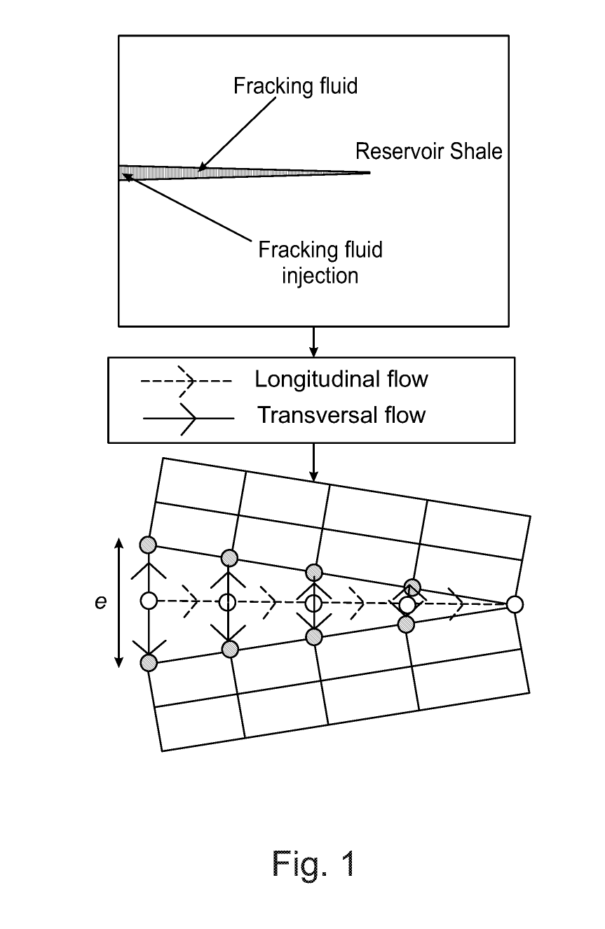

FIG. 1 is a schematic diagram of the interaction between the fluid pressure in the fracture region and the fracture surface;

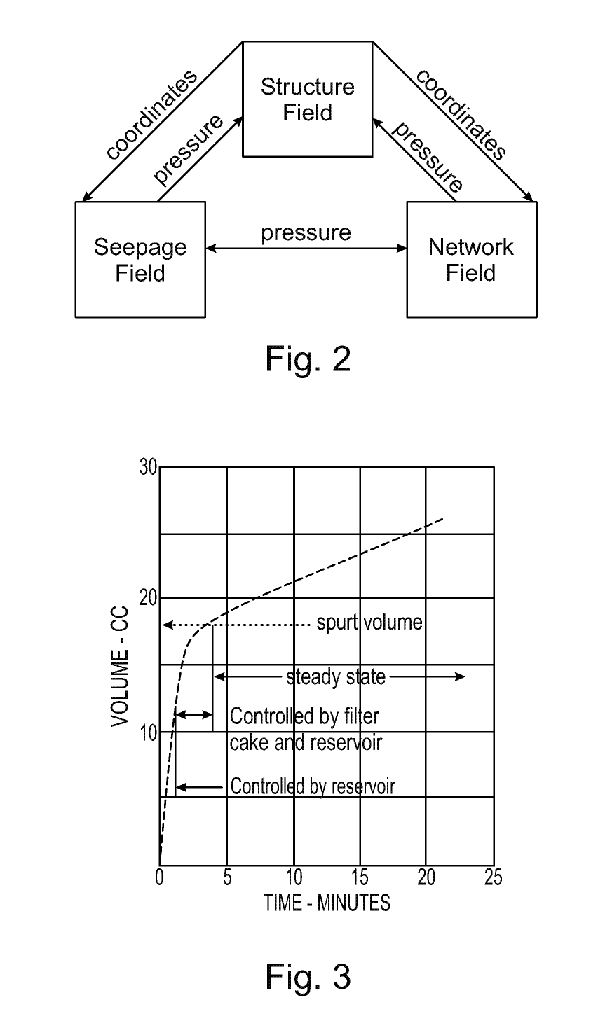

FIG. 2 is a schematic of the coupling between the main three fields in the analysis: mechanical, seepage and network;

FIG. 3 is a typical leak-off graph, measured by experiment, which can be captured by the method of the present invention;

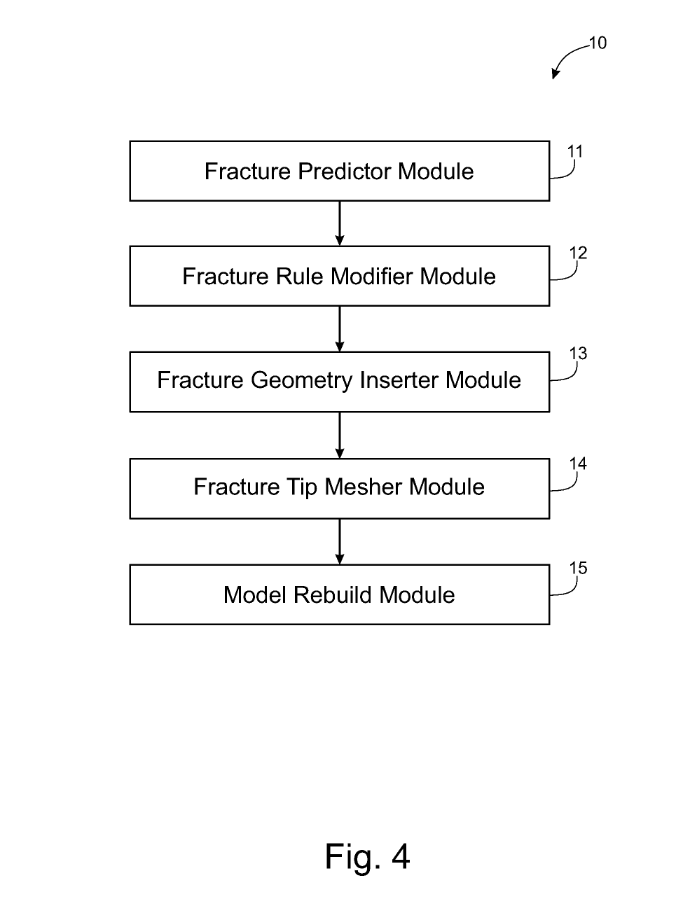

FIG. 4 is a schematic of the processor unit of the present invention;

FIG. 5 is an illustration in principal stress space of the Mohr-Coulomb yield envelope with a Rankine cap;

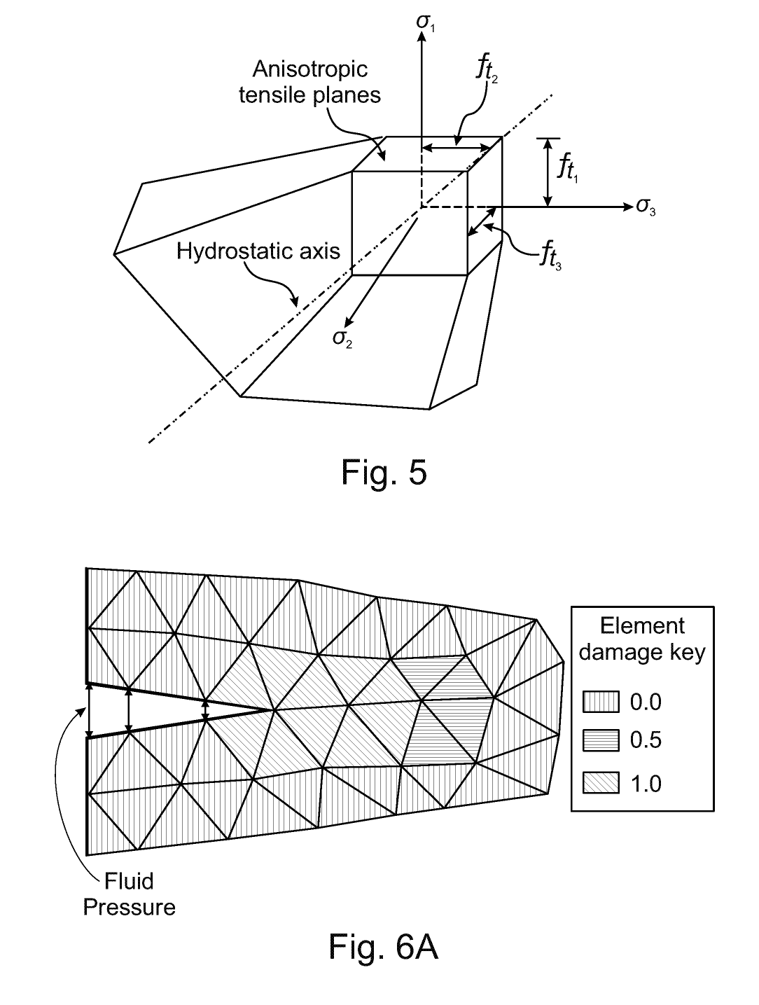

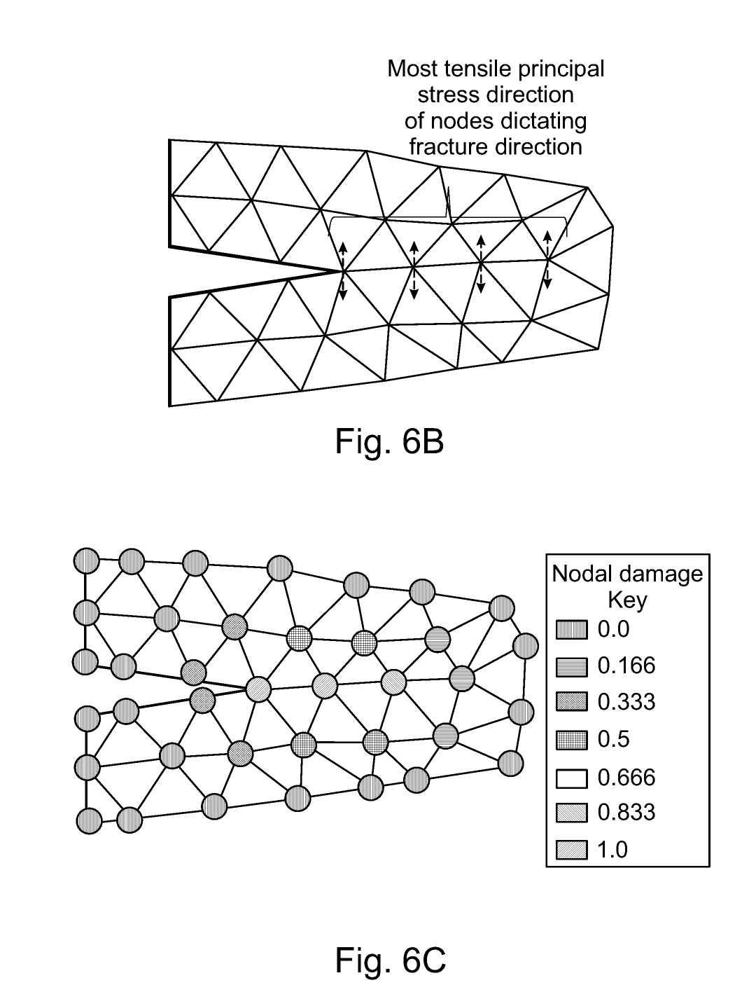

FIG. 6 A-C is an illustration of mapping the element damage to the mesh nodes that determines the predicted fracture length wherein:

FIG. 6A shows element or integration point damage;

FIG. 6B shows most tensile principle stress direction;

FIG. 6C shows interpolated nodal damage;

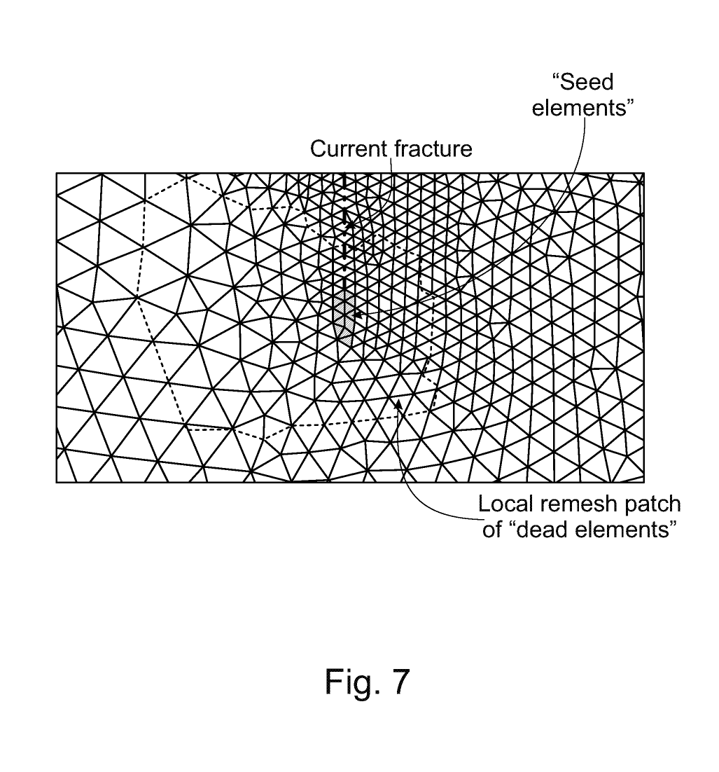

FIG. 7 is a model example of the patch region, i.e. local remesh region around fracture tips, along with the definition of “seed” and “dead elements”; and

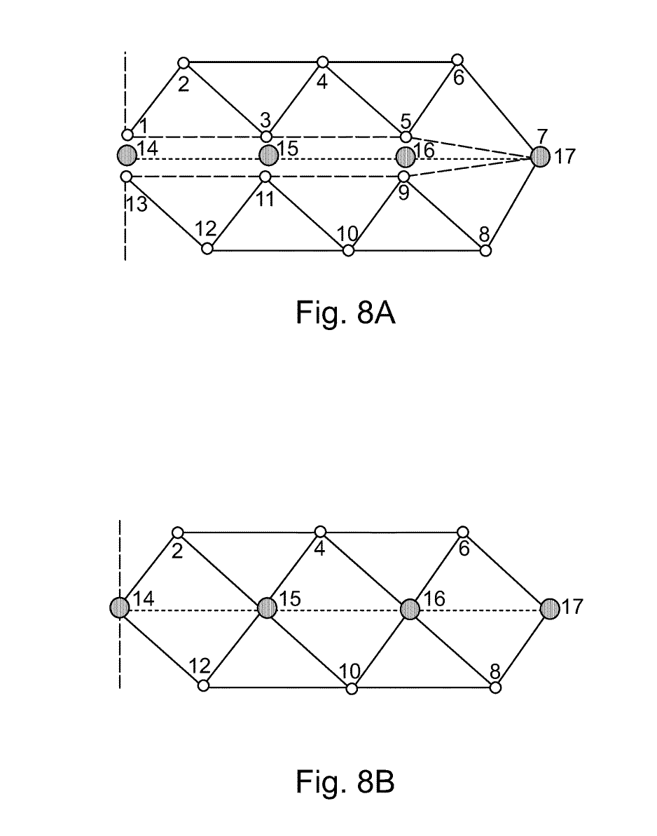

FIG. 8A-B is a model illustration of building the geometry once a fracture (or initially, a polyline) is inserted into the model, wherein:

FIG. 8A shows pre-merge with parent-child node relationship between network and fracture network nodes; and

FIG. 8B shows post-merge with parent-child node relationship between network and fracture network nodes.

The fracture insertion framework of the present invention is built around a coupled geomechanical mechanical-seepage-network system of governing equations. For illustrative purposes, FIG. 1 shows a schematic illustration of the modelling idealisation of the method of the present invention.

The main mechanical governing equation dictating the interaction between reservoir stresses and strains is given by:

L^{T}(σ′−αampₗ)+ρg=0 Eq. (1)
where L is the spatial differential operator, σ′ is the effective stress tensor given by a mechanical constitutive law, α is the Biot coefficient, m is the identity vector, pₗ is the pore fluid pressure, ρ is the bulk density, ρₗ is the pore fluid density, ρₛ is the density of the solid grains, ϕ is the porosity and g is the gravity vector.

The evolution of the pore pressure field is given by a combination of the mass balance equation of each phase, followed by Darcy's law to establish a principle between pore fluid pressure gradients and pore fluid velocity.

The main mechanical governing equation dictating the fluid flow in the fracture region is given by:

$$\frac{\partial }{\partial x} [ \frac{{k}^{fr}}{{μ}_{l}} ( ∇ {p}_{l} - {ρ}_{l} g ) ] = {S}^{fr} \frac{\partial {p}_{l}}{\partial t} + α \frac{\partial {e}_{ɛ}}{\partial t} \qquad Eq . ( 2 )$$

where k^{fr} is the intrinsic permeability of the fracture region and is equated to represent the well-known cubic flow rule established for fluid flow between 2 smooth parallel plates, μₗ is the viscosity of the fracturing fluid, pₗ is the fracturing fluid pressure, ρₗ is the density of the fracturing fluid, S^{fr} is the storativity of the fracture region and e_{ε} is the fracture aperture strain and is a link between changes in fracture volume and fluid pressure based on the fracturing fluid stiffness.

The fracture tip undergoes large stress changes during fracture propagation, from a potentially high effective compressive stress to a tensile stress prior to fracture. During this process, the tip pore pressure can evolve due to changes in volumetric strain, resulting in a drop in pore pressure that effectively strengthens the tip. This interplay between effective stress and pore pressure is important in determining the fracture breakdown pressure. The technology can investigate the poro-mechanical behaviour at the fracture tip during fracture propagation.

An important consideration during hydraulic fracture modelling is treatment of the fracture tip during fracture insertion. In reality the interaction between fracture growth and fluid flow within the fracture is a continuous process, but initialisation of the newly generated network, or fracture, elements is required after their insertion. A number of treatments are possible and some are described here; initialisation of the fluid pressures such that it is: (1) equal to initial reservoir pore pressure value; (2) equal to initial reservoir total stress value; (3) other prescribed value. The stress values in the patch region are constructed via a mapping between the old and new mesh.

The fractures evolves via the solution of a coupled finite element geomechanical mechanical-seepage-network system. FIG. 2 shows a representation of this system. The mechanical field accounts for the evolution of the effective stresses within the reservoir as the hydraulic fracture propagates. This principally takes place due to fluid pressurisation of the hydraulic fracture and its evolution in time. Additionally, the Rankine cap constitutive model accounts for the mode-1 weakening of the fracture tip during propagation; other criteria can be used for mode-II and mode-III fractures. The seepage field computes the change in pore fluid pressure in the reservoir due to fluid pressure gradients or volume strains within the reservoir. The network field solves for the fluid pressures along the fracture as the fracture propagates. The main governing equation that dictates how the fluid flows within the fracture is given via the mass balance equation in conjunction with a constitutive model that ensures that the cubic flow rule, obtained via consideration of fluid flow between smooth parallel plates, is honoured.

To mimic weakening of the fracture tip during propagation necessitates the use of strain-softening constitutive models. These might be unstable when computed within an implicit solution framework. For this reason it was decided to use an explicit-implicit solver to advance all the field solutions in time, i.e. mechanical displacements, seepage pore fluid pressures and network fluid pressures. The explicit solver is used to compute the mechanical stresses and an implicit solver is used to compute both the pore fluid pressure within the reservoir and the fluid pressure within the hydraulic fracture. The coupled variables in each governing equation are communicated via a staggered coupling scheme.

1D Carter models mimic the leak-off of fracturing fluid into the reservoir. These include leak-off rates that are both dependent and independent of the fluid pressure difference between that of the fracturing fluid and the adjacent reservoir pore fluid pressure. FIG. 3 shows some typical leak-off rates. As an example, pressure difference independent leak-off is evaluated via:

$$t - {t}_{exp} < {t}_{sp} ; {q}_{l} = \frac{{V}_{sp}}{{t}_{sp}} \\ t - {t}_{exp} ≧ {t}_{sp} ; {q}_{l} = \frac{C}{\sqrt{t - {t}_{exp}}} \qquad Eq . ( 3 )$$

where Vₛₚ is the initial volume loss per unit area, t is the current time, tₑₓₚ is the time from which a fracture surface is generated (which is important since new surfaces are constantly created during hydraulic fracture propagation), tₛₚ is the spurt time, C is the constant leak-off coefficient and qₗ is the 1D fracturing fluid leak-off velocity.

During propagation, the fluid pressure difference between that of the fracturing fluid and the reservoir can cause leak-off and interaction between the two fluids. Furthermore, the interaction is complicated further by the changes in pore fluid pressure at the fracture tip due to mechanical effective stress changes. The first instance, with fluid being transferred into the fracture tip, could cause an overall weakening effect in this region, whereas the pore pressure drop due to volumetric change could cause an opposite strengthening effect. The relative weakening and strengthening effects will be, amongst others, a complicated function of initial effective stress, properties of both fluids and pressure differences across the fluid boundaries. The technology is systematically able to investigate the weighting of each variable and its overall influence on hydraulic fracture propagation.

Not only is leak-off important at the fracture tip, but also along the fracture length. As the fracture propagates its length can extend, from field observations provided by the oil industry and in the literature, to many 100's of metres. These newly created and extended fracture surfaces are often a fruitful region for leak-off and, once again, the interplay between the two fluids, fracturing and reservoir, plus the effective stress in the reservoir all play key parts in the hydraulic fracture propagation.

The fundamental principle around the insertion criteria is the combination of the finite element method to predict the stress evolution along with a geometry insertion technique to insert a new fracture into the model. This alliance allows remeshing to take place on a much smaller scale, relative to the domain size. The induced reservoir stress change due to hydraulic fracturing is often very small compared to the model size, so for this class of problems it is extremely inefficient to consider global remeshing and a local geometry insertion techniques overcomes many of these inefficiencies.

Fracture insertion is carried out through five sequential modules which form a processor unit 10 (see FIG. 4). The processor unit 10 comprises a fracture predictor module 11, a fracture rule modifier module 12, a fracture geometry inserter module 13, a fracture tip mesher module 14, and a model rebuild module 15. Each of these modules is described in detail below.

The fracture predictor module 11 predicts the fracture direction and length. Mode-1 failure is captured via the Mohr-Coulomb with a Rankine cap constitutive model, as shown in FIG. 5. Damage values are evaluated at the finite element integration points during the fluid pressurisation of the hydraulic fracture. The element integration points' values are interpolated to the nodes from which a direction can be determined with the crack tip forming the starting position. This is known as a non-local fracture prediction approach.

The failure path is predicted by a patch of damaged adjacent elements and is computed as follows: (1) monitor the nodal failure factors and when a node's value exceeds a defined value, e.g. fully damaged, introduce this node into the failure path; (2) extend failure path as adjacent elements in the fracture direction fully, and/or partially fail. In this sense fracture direction is defined as the perpendicular to the maximum tensile principle stress (for mode-I failure); and (3) once the crack length, measured from the crack tip and through the damaged nodes, reaches a user-specified threshold then a fracture is inserted into the model.

Accumulated contiguous zones of damage determine the fracture direction, as shown in FIG. 6A-C.

FIG. 6A shows element or integration point damage, FIG. 6B shows most tensile principle stress direction and FIG. 6C shows interpolated nodal damage of the finite element mesh.

Additional constraints are placed on the fracture direction based on the angle of the contiguous zone relative to the crack tip. Otherwise, curvatures of the fractures could be predicted which are unrealistic when compared to field observational data. In principle, a number of contiguous damaged zones could form from the crack tip but the fracture insertion is based on the contiguous damaged region that first surpasses the user-specified threshold crack length.

Only the fracture tips, regions called patches (see FIG. 7), are remeshed during fracture insertion, rather than global remeshing. This is much more computationally efficient.

The fracture ruler modifier module 12 is necessary to ensure that fracture direction and length is physically realistic and also to mitigate small geometric detail within the numerical model that could cause meshing difficulties. This includes matters such as ensuring that proposed fracture paths terminate with pre-existing fractures or bedding planes. This essentially involves modifying the fracture path by extending or trimming the predicted fracture geometry to another geometric entity. This module is of great importance when a model contains many pre-existing fractures or many inter-beds, as would be the case for a heavily laminated reservoir rock.

The fracture geometry inserter module 13 prepares the geometry for local remeshing. A key requirement within the coupled geomechanical mechanical-seepage-network field analysis is that the nodes on either side of a fracture match with the nodes on the fracture flow network. Leak-off takes place at the nodal level so a parent-child relationship must be set-up at the mesh level.

To create a matching matrix and flow network mesh the fracture surfaces and the flow network elements are initially merged to a single geometric line and subsequently meshed, see FIGS. 8A,B. FIG. 8A shows pre-merge with parent-child node relationship between network and fracture network nodes and FIG. 8B shows post-merge with parent-child node relationship between network and fracture network nodes. The fracture geometry inserter module 13 also inserts the proposed fracture path polyline as defined by the fracture predictor module 11. In addition, the elements that intersect the polyline are also identified and labelled as “seed elements” in preparation for the next module, see FIG. 7.

During fracture insertion remeshing is only carried out in the patch regions. The seed elements with assigned density of the new mesh are passed to a mesher module 14 with the new fracture surface definition. The fracture tip mesher module 14 automatically expands the amount of elements to be remeshed in order to maintain a reasonable mesh density gradient. The seed elements and the extra elements are referred to as “dead elements” or elements that are to be remeshed, see FIG. 7.

The model rebuild module 15 comprises two parts: (1) Rebuild of the model geometry and mesh, recreating fracture discrete geometry, and (2) Mapping the stresses and material state parameters between old and new patch meshes.

Rebuilding is the first task that expands the continuum geometry to form discrete fractures and fracture network elements with the new propagating fracture geometry.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The mere fact that certain measures are recited in mutually different dependent claims does not indicate that a combination of these measures cannot be used to advantage.

1. A computer implemented method of modelling a hydraulically driven fracture, comprising:
predicting a direction and a geometry of a fracture using a finite element method; and
inserting a new fracture into the model using a geometric insertion technique.

2. The method of claim 1, wherein the finite-element method is a combined finite element-discrete element method.

3. The method of claim 2, wherein the direction and length of the fracture is predicted using a non-local damage prediction approach.

4. The method of claim 3, wherein the non-local damage prediction approach includes taking account of one or more of: stress state, material properties, heterogeneity, leak-off of fracturing fluid, and/or pore pressure fluid at the fracture tip.

5. The method of claim 4, wherein the combined finite-discrete element method takes account of pre-existing interfaces or layers encountered by the fracture.

6. The method of claim 1, further comprising the step of modifying the geometry of the fracture to ensure that the direction and length of the fracture is physically realistic and/or to mitigate geometric details which may cause meshing difficulties.

7. The method of claim 6, comprising modifying the geometry of the fracture by extending or trimming the predicted geometry of the fracture with respect to a pre-existing fracture geometric entity, such as another fracture or inter-bed.

8. The method of claim 1, wherein predicting the direction and the geometry of the fracture comprises predicting the direction and the geometry of the fracture in either two dimensions or three dimensions.

9. The method of claim 1, further comprising conducting remeshing of the model after insertion of the new fracture.

10. The method of claim 9, wherein the remeshing is conducted locally proximate the tip of the fracture only.

11. The method of claim 10, further comprising one or more of the following steps:
marking the elements of the finite element mesh identified during a non-local damage calculation as seed elements;
assigning a new mesh density (new element sizes) to the seed elements;
expanding the domain to be remeshed around the seed elements in order to achieve a mesh density gradient above a given threshold, wherein the seed elements and the elements in expanded domain are referred to as dead elements;
performing remeshing of the finite element mesh in the domain defined by dead elements only.

12. The method of claim 9, further comprising rebuilding the model geometry and mesh following insertion of the new fracture.

13. The method of claim 12, wherein the step of rebuilding includes mapping the stresses and material state parameters between old and new regions of the mesh.

14. The method of claim 1, comprising predicting the stress evolution of the fracture using the finite element method.

15. The method of claim 1, comprising modelling the pressure evolution and the flow of the hydraulic fluid in the fracture to ensure that the fracture growth and flow of the hydraulic fluid are continuous processes.

16. A computer implemented method of modelling a hydraulically driven fracture, comprising:
predicting a direction and a geometry of a fracture using a finite element method;
inserting a new fracture into the model; and
conducting local remeshing of the model proximate the tip of the fracture.

17. The method of claim 16, wherein conducting local remeshing proximate to the fracture tip comprises one or more of following steps:
marking the elements of the finite element mesh identified during a non-local damage calculation as seed elements;
assigning a new mesh density (new element sizes) to the seed elements;
expanding the domain to be remeshed around the seed elements in order to achieve a mesh density gradient above a given threshold, wherein the seed elements and the elements in expanded domain are referred to as dead elements;
performing remeshing of the finite element mesh in the domain defined by dead elements only.

18. The method of claim 16, wherein the method is a combined finite-discrete element method.

19. A method of extracting hydrocarbon deposits via hydraulic fracturing, the method comprising:
modelling a hydraulically driven fracture using the computer implemented method of claim 1;
determining one or more parameters of the extraction process by optimising the model.

20. The method of claim 19, wherein the one or more parameters optimised by the computer implemented method include one or more of: the extraction location, the pressure of the hydraulic fluid, fracture dimension (length, height, and width), evolution of the effective stress and pressure in the reservoir, and/or the duration of the extraction process.

21. The method of claim 18, including the further step of pumping hydraulic fluid into a wellbore as per the computer implemented model.

22. An apparatus for modelling a hydraulically driven fracture, the apparatus comprising a processing unit comprising:
a fracture predictor module for predicting a geometry of a fracture using a finite element method;
a fracture geometry inserter module configured to prepare the geometry for remeshing; and
a fracture tip mesher module configured to conduct remeshing proximate the fracture tip.

23. The apparatus of claim 22, further comprising a fracture rule modifier module configured to ensure that the direction and length of the fracture is physically realistic and/or to mitigate geometric details which may cause meshing difficulties;

24. The apparatus of claim 22, further comprising a model rebuild module configured to:
i) rebuild the model geometry and mesh, inserting the new fracture tip geometry; and
ii) map the stresses and material state parameters between old and new regions of the mesh.

25. The apparatus of claim 22, further comprising a display unit to display the output of the processing unit.
